(19) United States
(12) Patent Application Publication
(10) Pub. No.: US 2012/0016640 A1
(43) Pub. Date: Jan. 19, 2012

(54) MODELLING WAVE PROPAGATION CHARACTERISTICS IN AN ENVIRONMENT

(75) Inventor: Damian Murphy, Yorkshire (GB)

(73) Assignee: The University of York, Yorkshire (GB)

(21) Appl. No.: 12/747,453

(22) PCT Filed: Dec. 9, 2008
(86) PCT No.: PCT/GB2008/051169

§ 371 Date: Sep. 27, 2011

(30) Foreign Application Priority Data
Dec. 14, 2007 (GB) 0724366.0

(51) Int. Cl. G06F 7/60; G06G 7/48

(52) U.S. Cl. 703/2; 703/5

(57) ABSTRACT

A method and apparatus are disclosed for simulating wave propagation in an environment. The method includes the steps of, via a first model of the environment generated with a first modelling method, simulating a first response of the environment in a time and/or frequency domain over a first portion of the domain, and via a further model of the environment generated with a further modelling method, simulating a further response of the environment in the time and/or frequency domain over at least one further portion of the domain.

The present invention relates to a method and apparatus for modelling and simulating wave propagation characteristics of an environment. In particular, but not exclusively, the present invention relates to a method for modelling wave propagation characteristics (such as acoustic characteristics) of an environment (for example a real or virtual space) using at least two modelling methods, each of which is utilised over a respective portion of a time and/or frequency domain.

Architects and composers have long known the dramatic gravitas that can be imposed upon music or spoken word through the creative use of acoustic spaces. This has been exploited for hundreds, if not thousands of years in places of worship and great concert halls by composers such as Mozart, Berlioz and Mahler. In more modern times the psychoacoustic cues that impart this sense of space are usually generated by sound engineers to give an acoustic image that differs from the listening environment into which the sound is actually delivered. Such techniques are often used in theatre, cinema and more recently, interactive multimedia applications and give the composer/audio engineer/sound designer the artistic freedom to place the sound source and listener where required with absolute and complete control.

Acousticians, engineers and practitioners have sought to better understand the underlying physical principles that govern the behaviour of sound in an enclosed or open space. This knowledge, when combined with modern computing techniques has yielded numerous models that aim to synthesize a Room Impulse Response (RIR) suitable to impart the notion of a particular acoustic environment upon an anechoic (or dry) sound. These techniques can be traced back to simple electro-mechanical devices, the first digital feedback networks, through to more modern techniques described below.

One option for acquiring RIRs is to make a direct measurement in the desired space although this can be both time consuming and logistically difficult. Another option (which is the only possibility if the RIR of a virtual space is required) is to use a computational model to produce a virtual RIR that is an accurate analogy of the equivalent real-world space.

Geometrical acoustic techniques are the most popular solution for virtual space modelling with known architectural acoustics modelling techniques making use of ray-tracing [A. Krokstad, S. Str\acute{ø}m & S. Sr\acute{ø}sdal, “Calculating the Acoustical Room Response by use of a Ray Tracing Technique”, J. of Sound Vibration, vol. 8, No. 1, pp. 118-125, 1968] and beam tracing [A. Farina, “Pyramid Tracing Vs Ray Tracing for the Simulation of Sound Propagation in Large Rooms”, Computational Acoustics & its Environmental Applications, pp. 109-116, Computational Mechanics Publications, Southampton, UK, 1995] techniques as well as others to derive RIRs as well as other more general acoustic properties. This is achieved by calculating a sufficient proportion of all the possible propagation paths that exist between a sound source and receiver through the geometric interaction of a sound-ray and the surfaces present in the model. Although these techniques produce RIRs appropriate for a digital implementation using delay lines, ray-tracing techniques have a number of limitations. The discrete, clearly defined reflection patterns that result from these geometrical methods have to be convolved with Head-Related Transfer Functions (HRTF) data in order to make them suitable for auralization purposes and they do not take into account wave interference effects. As such, these geometric methods are valid for high frequencies only and are less appropriate for low frequencies where the wave based properties of sound propagation and the presence of sparsely distributed modal frequencies tend to dominate. They are further limited in their ability to successfully model diffraction effects and hence by extension, sound occlusion due to objects being present in the propagation path, resulting in potential spatialisation errors. The rays used in ray-tracing have no cross-sectional area, whereas the rays used in beam-tracing are often conical or tetrahedral in shape and expand in area as they travel away from the sound source. This allows greater geometrical coverage than ray-tracing for the same number of rays or beams, resulting in quicker detection of valid source-receiver paths.

Finite Element Models and Boundary Element Models offer iterative methods for calculating the resonant frequencies present within an enclosed space. Although accurate these methods are computationally intensive, depending on dense mesh structures to produce results across the audible spectrum. These techniques have been used to create RIRs of virtual spaces, but alternative modelling techniques that produce equally valid results with less computational overhead and greater flexibility in terms of implementation and realization are currently more common. One such method uses the multi-dimensional digital waveguide mesh (DWM).

The digital waveguide mesh (DWM) was first proposed by Van Duyne and Smith [S. A. Van Duyne and J. O. Smith, “Physical Modeling with the 2-D Digital Waveguide Mesh”, Proc. Int. Computer Music Conf., Tokyo, Japan, 1993, pp. 40-47] as an extension to 1-D digital waveguide sound synthesis appropriate for modeling plates and membranes, potentially leading to full 3-D object modeling. The 1-D digital waveguide model is commonly used to model string and wind instruments, an approach similar to the Kelly-Lochbaum 1-D transmission line simulation of the vocal tract. Both of these 1-D models are based on a sampled traveling-wave implementation of the d'Alembert solution to the wave equation using bi-directional digital delay lines and scattering junctions. The reader is referred to J. O. Smith, “Physical Modeling using Digital Waveguides”, Computer Music Journal, vol. 16, no. 4, pp. 74-87, 1992 and J. O. Smith, “Principles of digital waveguide models of musical instruments”, Applications of Digital Signal Processing to Audio and Acoustics, M. Kahrs and K. Brandenburg, Eds., pp. 417-466, Kluwer Academic Publishers, Boston, 1998 for a thorough treatment and discussion of this area and a full derivation of the terms involved. Additionally, the interested reader is also directed to S. Bilbao, Wave and Scattering Methods for Numerical Simulation, John Wiley and Sons, Ltd., Chichester, UK, 2004 where the DWM is examined within a rigorous theoretical and comparative framework for more established, yet related wave scattering numerical simulation techniques.

From the basic 1-D digital waveguide model, higher dimension mesh structures are constructed using bi-directional delay line waveguide elements and scattering junctions which act as a regular grid of spatial and temporal sampling points within the modelled domain.

In particular since the DWM was first applied to the problem of room acoustics simulation by Savioja et al. in 1994 [L. Savioja, T. J Rinne and T. Takala, “Simulation of Room Acoustics with a 3-D Finite Difference Mesh”, Proc. Int. Computer Music Conf., Denmark, 1994, pp. 463-466], related research has been focused in a number of areas. There has been some considerable exploration of the properties and use of mesh topologies in 2-D or 3-D. Significant effort has also been applied to the accurate simulation of DWM boundaries with a view to how the physical properties of real materials might be modelled.

Whilst significant effort has been applied to the use of 2-D or 3-D mesh topologies, it is to be understood that such modelling techniques of high quality DWM based RIR synthesis for reverberation, auralization and virtual environment modelling demands a full 3-D render at high sample rate. Unfortunately this brings with it prohibitive execution times and costly hardware to bring the run times anywhere near acceptable levels.

A further reason for the lack of DWM methods in more general room acoustics modelling is that no intuitive software exists for the non-specialist and specialist alike to experiment with. At present the generation of RIRs using DWM models requires meticulous and time consuming editing of computer code to set up all but the simplest room geometries and mesh topologies. This means that any research scientist wishing to do work in the field has a steep learning curve to overcome as they write and maintain their own code base, making it difficult to quickly try out new ideas and share knowledge.

It is an aim of the present invention to at least partly mitigate the above-mentioned problems.

It is an aim of embodiments of the present invention to provide a method for modelling wave propagation characteristics of an environment in a way that a model having an acceptable level of accuracy can be utilised in a reasonable period of time. Embodiments of the present invention provide a model able to run close to or at real time limits.

It is an aim of embodiments of the present invention to provide a method and apparatus for modelling wave propagation characteristics of an environment using a hybrid simulation technique. Use is made of a combination of high resolution modelling techniques and coarser resolution modelling techniques as appropriate. This strikes a balance between an acceptable level of resolution and thus realism whilst maintaining an acceptable level of computational time and hardware resources required.

According to a first aspect of the present invention there is provided a method for simulating wave propagation in an environment, comprising the steps of:
via a first model of the environment generated with a first modelling method, simulating a first response of the environment in a time and/or frequency domain over a first portion of the domain; and
via a further model of the environment generated with a further modelling method, simulating a further response of the environment in the time and/or frequency domain over at least one further portion of the domain.

According to a second aspect of the present invention there is provided a computer program comprising computer program code means adapted to perform all the steps of any one of claims 1 to 27 when said program is run on a computer.

Embodiments of the present invention provide a method for modelling wave propagation characteristics of an environment, such as acoustic characteristics of a bounded virtual space, using a hybrid modelling technique. One modelling method is used to model a response of the environment over a first portion of a time and/or frequency domain whilst at least one further modelling method is used to model a response of the same environment over a further portion of the time and/or frequency domain. The first portion of the time and/or frequency domain is selected so as to contain information having a highest level of perceptual relevance. Alternatively, the first modelling method used has a level of accuracy or computational efficiency higher than that of the other modelling method/s used. The further portion of the time/frequency domain can include all or part of the first portion or may be separate and distinct.

Embodiments of the present invention will now be described hereinafter, by way of example only, with reference to the accompanying drawings in which:

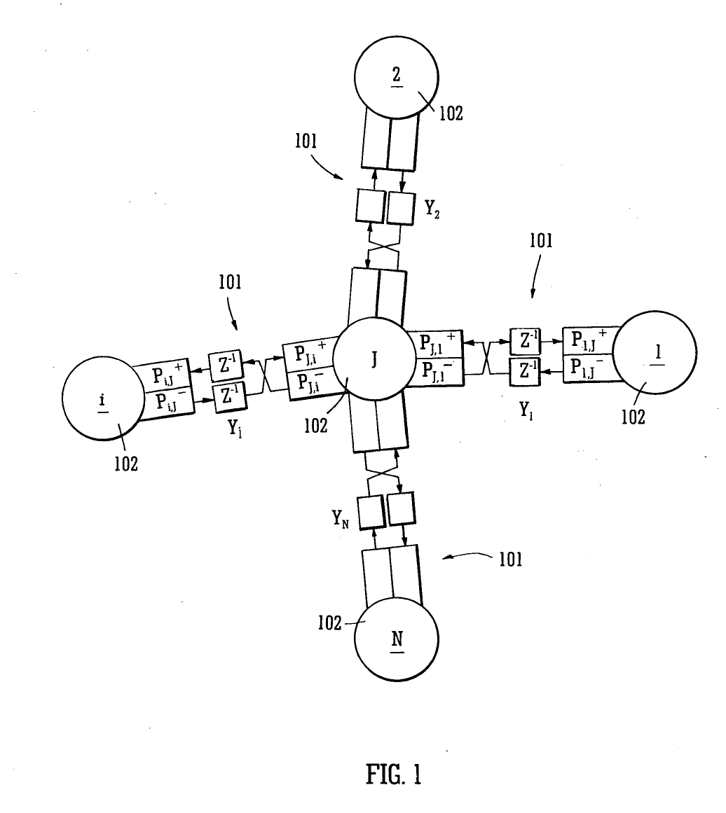

FIG. 1 illustrates a scattering junction with connected waveguides:

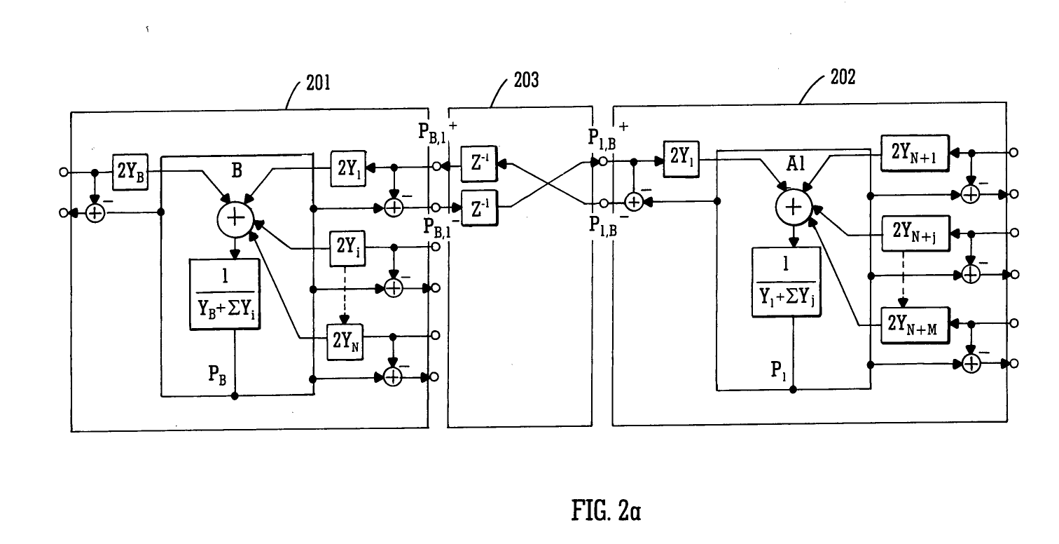

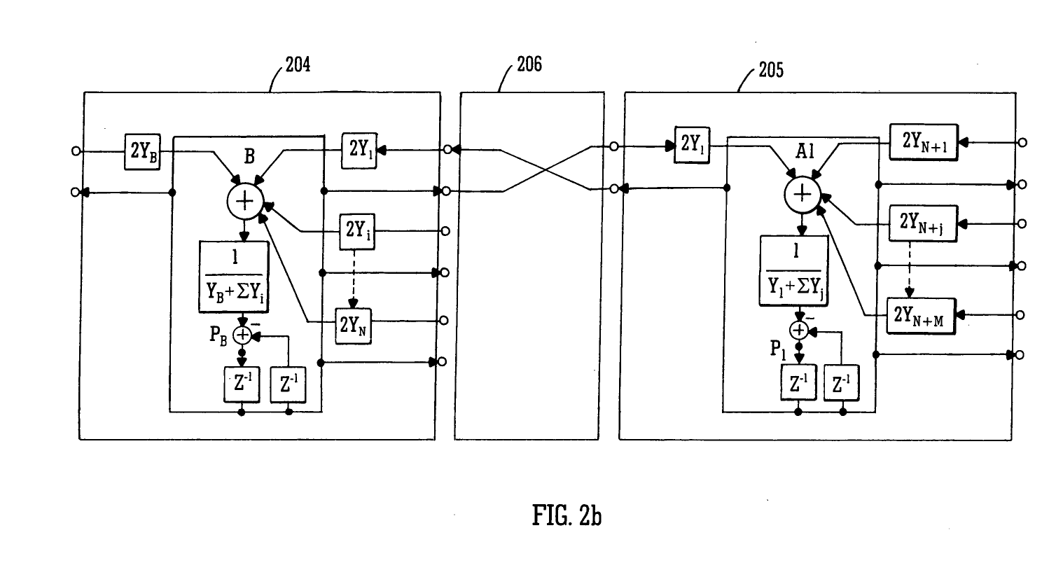

FIG. 2a illustrates two W-DWM nodes connected via a waveguide;

FIG. 2b illustrates two K-DWM nodes connected via a waveguide;

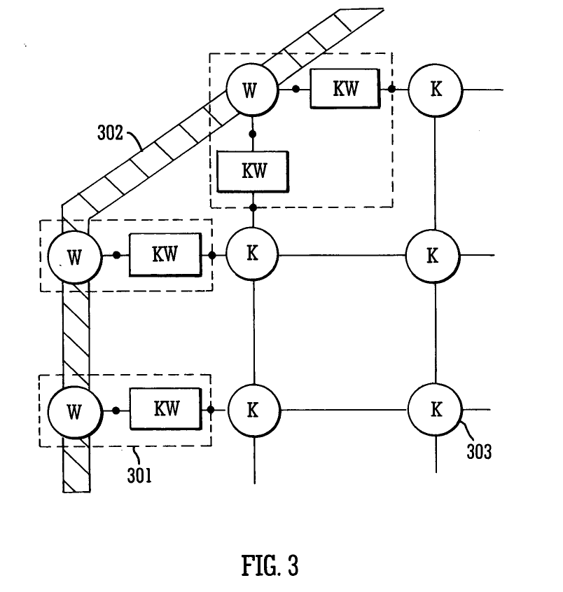

FIG. 3 illustrates a 2-D rectilinear hybrid DWM structure;

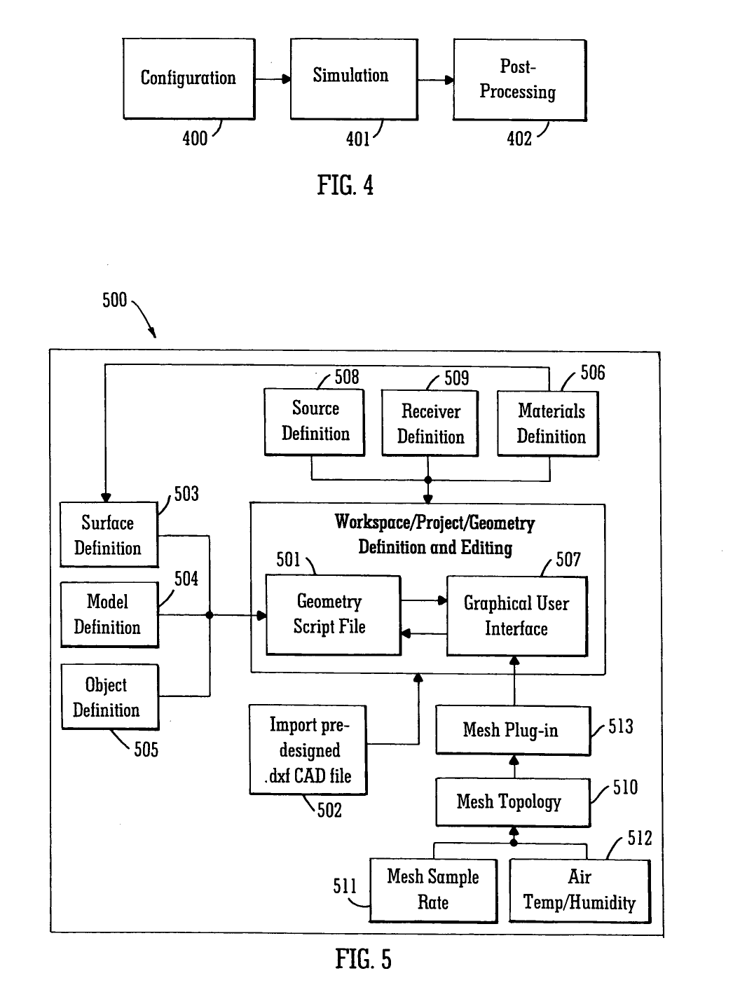

FIG. 4 illustrates stages during simulating wave propagation in an environment:

FIG. 5 illustrates configuration;

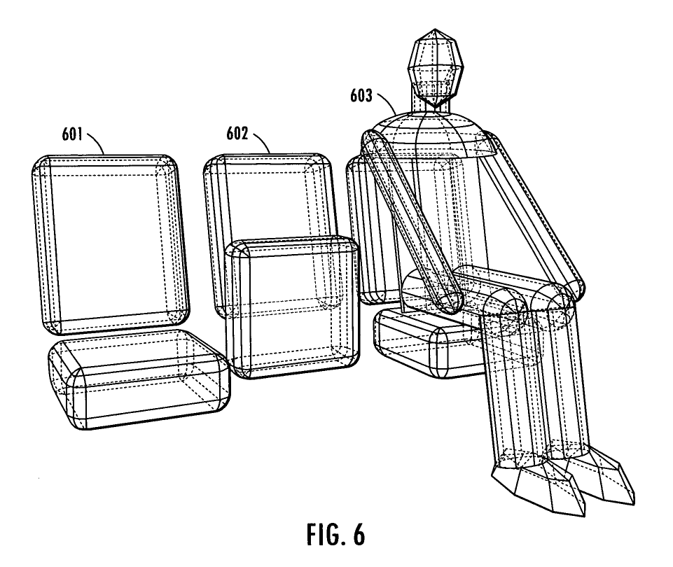

FIG. 6 illustrates an object to be placed in an environment;

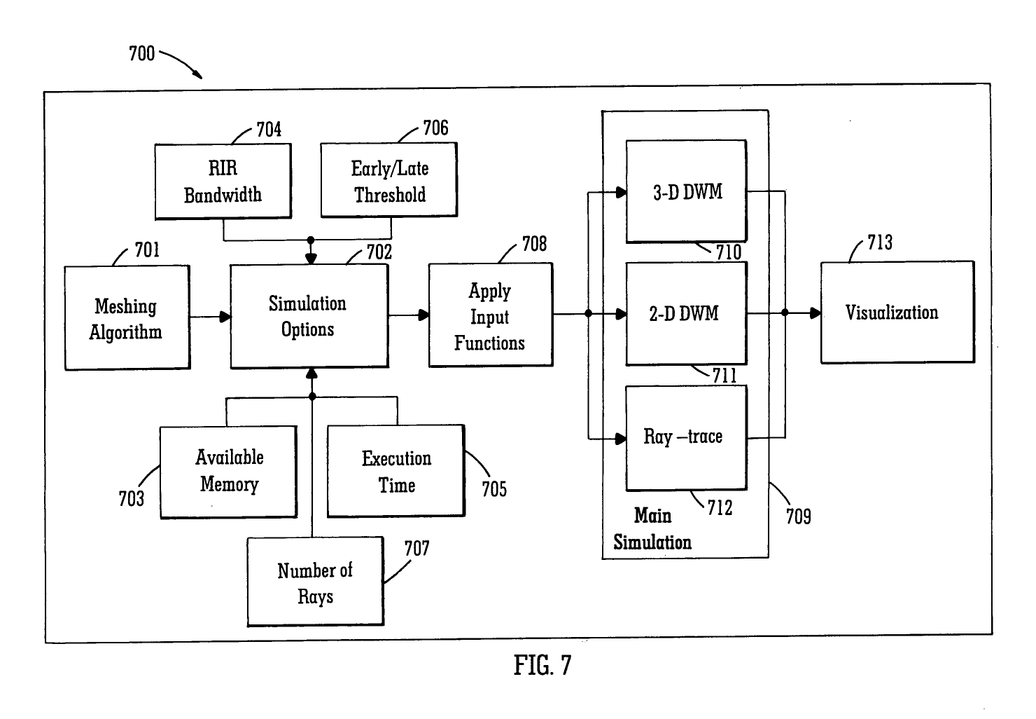

FIG. 7 illustrates simulation;

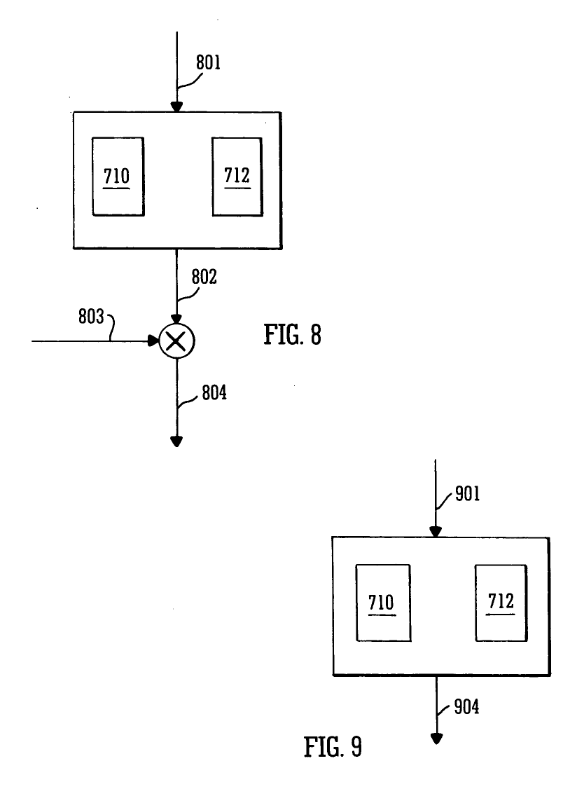

FIG. 8 illustrates a simulation;

FIG. 9 illustrates a simulation;

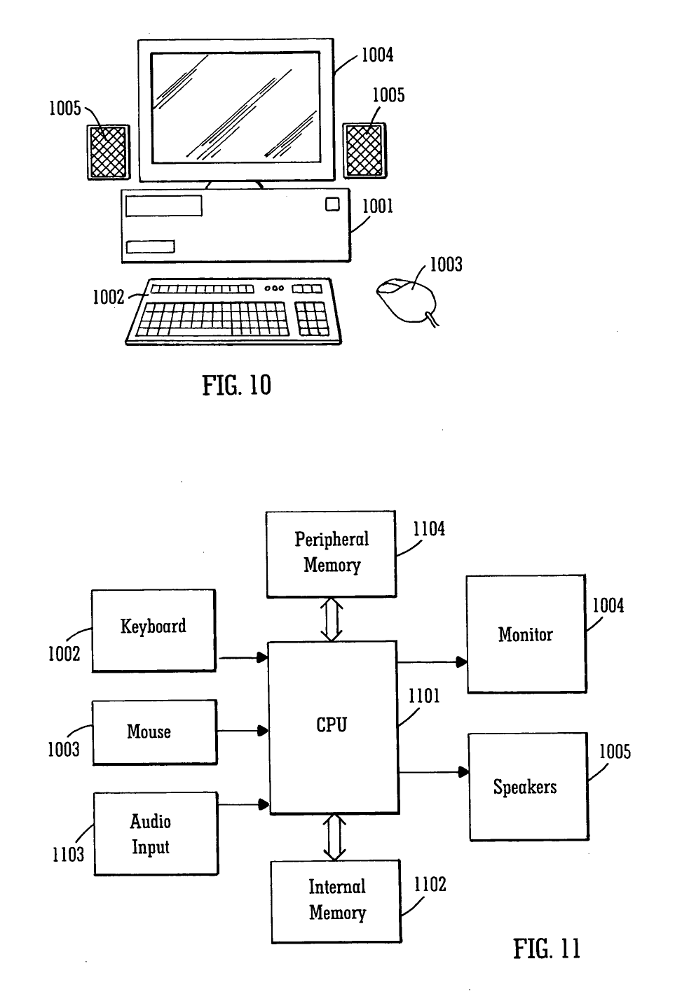

FIG. 10 illustrates a computer system;

FIG. 11 illustrates functional elements of a computer system;

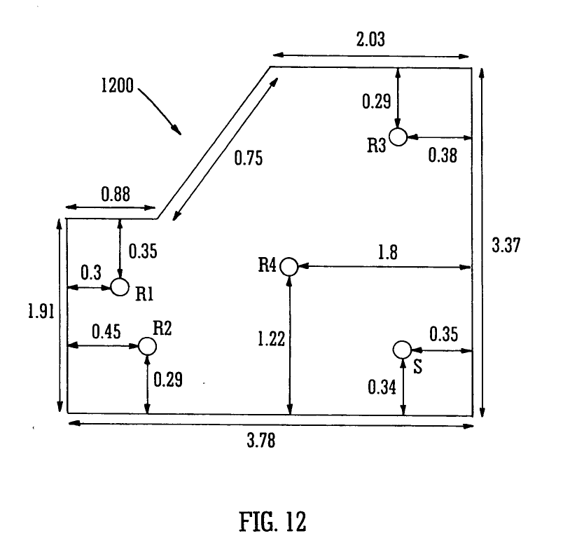

FIG. 12 illustrates an environment;

In the drawings like reference numerals refer to like parts.

Throughout this specification reference will be made to the term “environment”. It is to be understood that the term environment is to be broadly construed to include any region in which waves may propagate. The environment may, for example, be a space which is bounded or open on one or more sides. The environment may be empty or may include matter such as air or fluid or solid. The environment may include a combination of these. The environment may also include identifiable physical objects such as a chair or desk located in a particular locale.

Reference will also be made throughout this specification to the term “modelling”. Modelling involves the process of producing a model of, for example, part or parts or the whole of an environment. The model may be of an environment's physical characteristics alone or may be a model of wave propagation characteristics of the environment. That is to say a model of how waves may propagate through the environment. The model may alternatively be a combination of wave propagation characteristics and physical characteristics.

Reference will be made throughout this specification to the term “wave propagation”. It is to be understood that this term is to be broadly construed so as to cover, for example, the propagation of sound waves through an environment or other forms of wave flowing or otherwise moving through a medium.

Reference is made throughout this specification to the term “simulating”. It is to be understood that this term is to be broadly construed and includes steps carried out to estimate how properties or parameters of one feature will react when under the influence of other effects.

Reference will be made throughout this specification to an “excitation source signal”. An excitation source signal is a signal that can be used to extract acoustic characteristics of an environment. When such a signal is applied to a model of wave propagation characteristics of an environment, a response from the model will contain a time domain spread or frequency response of characteristics of the model. An excitation source signal can be an impulse or swept sign wave or other type of excitation source.

It is to be understood that a “virtual space” is a model of a space. Such a model may be a representation of a real/physical space or an imaginary space. However, in both circumstances the model is not a real space, it is not tangible and is therefore virtual.

A “real/physical space” is a space that exists in real life. It is tangible. It has physical, acoustic, and many other characteristics associated with it as does any real space or object.

FIG. 1 illustrates a scattering junction J with N connected waveguides which can be used to illustrate how a model of an environment can be constructed. In particular FIG. 1 illustrates how a digital waveguide mesh (DWM) 100 can be constructed using bi-directional delay line waveguide elements 101 and scattering junctions 102 which can be joined together as a regular grid of spatial and temporal sampling points within a modelled environment. It will be understood that in referring to waveguides there is no need for a specific element to be identifiable. Rather features having the functionality of a waveguide are sufficient.

Reference will be made throughout this specification to the modelling of characteristics of an environment. Such an environment may be a real environment or virtual environment and may be bounded or open.

The sound pressure in a waveguide element 101 is represented by pᵢ, the volume velocity by vᵢ and the impedance of the waveguide element by Zᵢ where pᵢ/vᵢ=Zᵢ. The admittance Yᵢ is the inverse of Zᵢ, such that Yᵢ=1/Zᵢ. The input to a waveguide is termed pᵢ⁺ and the output pᵢ⁻. The signal p_{J,i}⁺ therefore represents the incoming signal to scattering junction J along the waveguide element from the opposite junction i. Similarly, the signal p_{J,i}⁻ represents the outgoing signal from junction J along the waveguide to the opposite junction i. FIG. 1 shows the general case of a scattering junction J with N neighbours, i=1, 2, . . . , N, with each connected unit waveguide element having an associated admittance Yᵢ.

From the d'Alembert solution to the 1-D wave equation the total sound pressure p_{J} in a waveguide element connected to junction J can also be defined as the sum of the travelling waves in this element, or alternatively as the sum of the input and output:

p_{J}=p_{J,i}⁺+p_{J,i}⁻ (Eq1)

By determining that for a lossless junction J the sum of the input velocities is equal to the sum of the output velocities, and that the sound pressures in all crossing waveguides are equal, the sound pressure p_{J} at junction J for N connected waveguides can be expressed as:

$${p}_{J} = \frac{2 {\sum }_{i = 1}^{N} {Y}_{i} \cdot {p}_{J , i}^{+}}{{\sum }_{i = 1}^{N} {Y}_{i}} \qquad ( Eq 2 )$$

As the waveguide elements in a DWM are equivalent to bi-directional unit-delay lines, the input to scattering junction J at time index n, p_{J,i}⁺ (n), is equal to the output from neighbouring junction i into the connecting waveguide at the previous time step, p_{i,J}⁻(n−1). Expressing this relationship in the z-domain gives:

p_{J,i}⁺=z⁻¹·p_{i,J}⁻ (Eq3)

Hence from (Eq2) junction pressure values are calculated according to input values from immediate neighbours, output values are calculated using (Eq1) and then propagated to neighbours via the bi-directional waveguide elements, becoming inputs at the next iteration according to (Eq3). From (Eq1), (Eq2) and (Eq3), via an appropriate linear transformation, it is possible to derive an equivalent formulation in terms of junction pressure values only:

$${p}_{J} = \frac{2 {\sum }_{i = 1}^{N} {Y}_{i} \cdot {p}_{i} \cdot {z}^{- 1}}{{\sum }_{i = 1}^{N} {Y}_{i}} - {p}_{J} \cdot {z}^{- 2} \qquad ( Eq 4 )$$

This expression can also be derived directly from a finite difference time domain (FDTD) formulation of the wave equation. A digital waveguide model generally refers to a representation of acoustic signal propagation via two directional wave components and schemes implemented in this way are termed W-models or W-DWMs. A linear transformation of a W-DWM leads to this alternative implementation as a Kirchhoff variable DWM (K-DWM), depending on physical quantities only rather than sampled travelling-wave components. In this form, and under certain conditions, a K-DWM can be computationally equivalent to an FDTD simulation. FIG. 2a shows a graphical representation of two adjacent W-nodes 201, 202 connected by a waveguide element 203, as defined by Eq1-Eq3, while FIG. 2b shows a graphical representation of two adjacent K-nodes 204, 205 connected by a waveguide element 206 as defined by Eq4.

W-DWMs are able to provide a better fit at the boundary of a more complex geometric structure due to the larger number of possible air-node connections and the additional modelling flexibility they offer. However, W-DWMs are computationally more inefficient than the equivalent K-DWM, relying on two independent passes through each element in the mesh data structure and greater memory resources. It is therefore advantageous to combine the fast and efficient K-DWM with the more flexible W-DWM. To enable these two different mesh types to be combined, a KW-pipe transform can be used as an interface between the two types of DWM nodes. A KW-pipe is an all-pass network that is delay-free when moving from K-node to W-node, and that introduces delay in the opposite direction from W-node to K-node, so allowing physical variable K-DWM models to be effectively connected to scattering W-DWM models. FIG. 3 shows a 2-D rectilinear hybrid DWM structure in which K-DWM and W-DWM structures are incorporated and combined within the same mesh structure via a KW-pipe interface. In this hybrid DWM the W-DWM/KW-pipe 301 models a boundary 302, while the K-DWM nodes 303 model geometrically simple areas of uniform structure such as air, or the inside of objects.

Embodiments of the present invention provide a cross-platform (Windows, Mac-Intel, Mac-PPC, Linux or others) DWM room acoustics modelling application, implemented in the style of an Integrated Development Environment (IDE) with a hierarchical data and file structure. It will be appreciated that embodiments of the present invention are not restricted to only acoustic modelling. Rather embodiments can model wave propagation characteristics generally, such as disturbance propagation through a fluid medium. A workspace contains one or more projects; each project contains the specification for the dimensions and contents of a particular real or virtual space or other such environment, defined as a Geometry. For each geometry different surface sets can be specified, various source and receiver configurations can be set up and a number of DWMs can be defined. This data can be browsed using the workspace navigator pane on a GUI or other such user interface.

FIG. 4 illustrates stages of simulating wave propagation such as acoustic wave propagation through an environment in accordance with embodiments of the present invention. The modelling process includes a configuration stage 400 during which dimensions and contents of a particular environment are specified as a geometry. Subsequently, during a simulation stage 401, the defined environment is populated with a 2-D or 3-D DWM either across a full region of the time and/or frequency domain or over a portion of the time and/or frequency domain as selected. Once the environment is defined an input signal is input at least one location in the environment and a response is measured at least one receiver location. A further portion of the time and/or frequency domain may be modelled with a 2-D DWM or Ray-trace or other user selected modelling method. A third, post processing, stage 402 may be utilised to improve the results of the simulation.

FIG. 5 illustrates a configuration block 500 used in the configuration stage 400. The configuration block may be configured in hardware or in software.

The size and shape of a room and all the objects in it are specified in terms of a number of planar surfaces together with their reflective/absorptive and diffusive properties. Standard Cartesian co-ordinates are used and so a surface is defined by specifying the locations of its corners relative to the system origin. Embodiments of the present invention can of course utilise other techniques and co-ordinate systems for defining surfaces and locations. By combining multiple surfaces into groups, complex shapes can be created and these can then be stored as Models and re-used as required. Files are written in a simple scripting language that allows variable manipulation, loops and conditional statements, enabling sophisticated models to be defined. Input parameters can also be used to control their properties. For example, a basic model of an auditorium chair 600 can be defined as open 601, closed 602 or occupied 603 as shown in FIG. 6. The occupied chair model uses a separately defined model for a sitting person. This enables a basic model to be defined as different objects.

As shown in FIG. 5, in this way the specification for the dimensions and contents of a particular virtual or real space are provided. For each geometry different surface sets can be specified, various source and receiver configurations can be set up and a number of DWMs can be defined. A Geometry can be defined and loaded into a project from either a Script File 501 or an imported CAD File 502 exported from another computer aided design (CAD) or 3-D graphics package. In the script file, the size and shape of a room and all the objects in it are specified in terms of a number of planar surfaces together with their reflective/absorptive and diffusive properties. This is input as surface definition 503. By combining multiple surfaces into groups, complex shapes can be created and stored as Models 504. These, combined with the objects 505 defined as per above, are used to generate the Script File.

Materials 506 are assigned to surfaces in the geometry file, but once loaded the materials on a boundary surface may be easily changed and saved as surface sets, allowing the same geometry to have several different profiles, and the effect of using different building or furnishing materials to be explored. These may be manipulated and edited via a GUI 507. A user extensible library of materials that can be applied to a surface (adapted from standard literature) is provided, which stores the absorption coefficients of each material for any number of incident angles at eight octave bands and the diffusion coefficient at the same octave bands for any number of surface sizes. Material properties may also be edited and new materials created from within the main program.

One or more sources 508 and one or more receivers 509 are placed according to their co-ordinates. Using the scripting language, groups of transducers can be created along with an associated geometry to produce, for example, a spaced stereo pair, a binaural RIR incorporating a dummy head, an Ambisonic first-order 4-channel B-format receiver or some higher order B-format receiver. For each source the input signal is specified in a wave or text file.

Once a virtual space has been defined the structure is populated with a model such as a 2-D or 3-D DWM. Plug-in architecture is used to allow different DWMs to be selected. A Mesh topology plug-in 510 is used to fit the desired basic N-port scattering junction structure into a cubic array representation, used internally to map out the space. Parameters such as the mesh sample rate 511 and Air Temperature/Humidity 512 variables are set. Mesh sample rate affects the valid bandwidth of the output RIRs. Air Temperature and Humidity values affect the Air Absorption Filter settings in the Post-Processing block. Once the topology is decided upon, a compatible mesh-type plug-in 513 may be selected and this refers to how the mesh is actually implemented, which may be as a K-, W-, or hybrid KW-DWM. The particular implementation of the mesh plug-in algorithm will affect the performance and ultimately the quality of the final RIR over and above theoretical considerations. Embodiments of the present invention utilise a single modelling method to model wave propagation characteristics of an environment. Other embodiments utilise a hybrid modelling method utilising one modelling method such as 3-D DWM and at least one further modelling method such as 2-D DWM or ray-tracing.

Operation of the simulation stage is illustrated in more detail with respect to FIG. 7. FIG. 7 illustrates a simulation block 700 used to simulate the environment being tested. The simulation block may be configured in hardware or software.

The meshing algorithm 701 fills the room geometry with a uniform spatial grid of DWM nodes. As the sampling grid arrangement of a DWM will vary according to the topology plug-in used and the arbitrary geometry of the defined virtual space, a generalized, flexible approach to filling the space is used:
1. A single air-node is placed at a user-defined seed-point within the geometry model and this node reproduces itself by sending out “creepers” along its ports into the surrounding empty space.
2. An identification is made to see if a boundary or existing air-node has been encountered. If not then a new air-node is created at the end of the creeper.
3. If a creeper discovers a surface then a boundary-node is created at the end of the creeper rather than an air-node. These boundary-nodes are incapable of reproduction and hence do not send out any creepers of their own.
4. If a creeper discovers another air-node then a connection between the two is established.
5. All new air-nodes will then send out their own creepers (and hence the space begins to fill with basic N-port air-nodes).

In this manner the meshing process will continue until the edge of the modelled space, or object geometry boundaries are encountered. When a boundary-node is created it inherits the properties of the particular surface associated with its geometrical location.

Although it is possible to run a 2-D or 3-D DWM, or a ray-trace simulation directly from this point embodiments of the present invention add additional flexibility and parallel modelling options. The user is provided with information identifying system parameters based on the current system resources, with the maximum available memory input 703 determining the maximum bandwidth of the final RIRs. An input RIR Bandwidth 704 allows the user to reduce this value further, so improving execution time. An input Execution time 705 may be reduced or extended based on the time the user is prepared to wait for the RIRs to be generated. As a minimum execution time is determined by an Early/Late threshold input 706 the threshold input is set to determine where a cut in the time and/or frequency domain is made. This may be dependent upon dimensions of the environment being modelled as a larger space will take longer for direct sound and early reflections from one or more sources to reach a receiver. For a reduced bandwidth or execution time 3-D DWM simulation, the remainder of the output may be replaced by a 2-D DWM simulation with similar parameters, or a ray-trace, with quality determined by the number of rays input 707 (provided by the user) actually traced. The Input block 708 loads the appropriate excitation files into the simulation prior to execution ready for the main simulation 709 which may be carried out as a 3-D DWM 710 and/or a 2-D DWM 711 and/or a ray-trace 712 or other modelling method or any combination of these according to the selected option. By updating the state of each node according to the DWM algorithm used one sample at a time the excitation signals propagate through the mesh. Alternatively in the ray-trace case virtual sound rays are fired off into the space until they encounter a surface where they are reflected/absorbed/diffused as appropriate. A visualisation block 713 allows the DWM process to be viewed using an animation where the pressure at each node is represented by either a coloured bar or point. The ray-trace option may also be viewed if required. The simulation is terminated either when the required number of samples have been generated or when the signal level falls below a specified value.

An optional post processing stage 402 may then be utilised to process the signals output from the simulation block. An output of the post processing block provides a final complete RIR wave file for each simulation run.

FIG. 7 illustrates schematically how wave propagation through an environment can be simulated. Via a graphical user interface 507, a user first defines an environment, such as a bounded virtual space identifying surface characteristics including dimension and surface materials. This is the configuration stage 400 noted above with respect to FIGS. 4 and 5. A user then selects one or more modelling methods to produce models indicating wave propagation characteristics of the space. It is possible for a user to select only one model, for example, a high accuracy 3-D digital waveguide mesh. However, it is understood that modelling using such a modelling type is computationally expensive and time-consuming. A user may therefore utilise a hybrid modelling scheme which utilises more than one modelling type to estimate wave propagation through an environment. By identifying parts of a response which are of most significance and which are therefore modelled with a modelling type having a high level of accuracy and modelling a remainder with a modelling type of less accuracy, a compromise is reached which provides a satisfactory level of accuracy but in an acceptable level of time or having an acceptable hardware requirement. For example, a user may select to use a 3-D digital waveguide mesh 710 and a ray-trace 712. Each model will be used to model wave propagation caused by one or more input signals over an associated portion of a time and/or frequency band. For example, it has been appreciated that typically up to the first 100 milliseconds of the impulse response of a space contains the most perceptually relevant information. That is to say, a person can determine more or less accurately information relating to a space by listening only to the first 100 milliseconds. The tail (or latter part) of a signal contains less perceptually relevant information that is less critical in terms of low level content. Therefore a model such as the 3-D digital waveguide mesh 710 is typically utilised over the first 100 milliseconds in the time domain. This portion of the time domain response contains the most critical relevant information in terms of perceiving the size and shape of the space. A ray-trace model is utilised to model the wave propagation during a remainder portion of the time domain. This portion of the time domain includes less perceptually relevant information and therefore a cruder (but quicker and less processing intensive) modelling technique can be used. It is to be understood that embodiments of the present invention can utilise two or more models to provide a hybrid modelling methodology to produce a result representing how waves will propagate in an environment. It is also to be understood that the portion of the time and/or frequency domain which is selected by a user can be chosen to strike a balance between obtaining acceptably accurate results in a reasonable time or using a reasonable amount of processing power and thus cost.

As illustrated in FIG. 8, an excitation source signal 801 is used to stimulate each model. A response from each model is then combined. The combined response provides a room impulse response RIR of the environment. The output from the models is then convolved or otherwise combined with an input signal 803 which may be an anechoic signal. An anechoic signal includes no reverberant information. Effectively the anechoic signal provides a signal identifying a sound which is to be modelled in an environment. The output from the models when convolved with that sound provide a final output 804 indicating how the anechoic signal will be affected by the environment. In the example of the anechoic signal being an acoustic signal the final output 804 will provide an indication of how that sound would be heard by a person in the selected environment. Post processing 402 may be carried out on the final output signal 804 to improve the quality of the result.

FIG. 9 illustrates a further embodiment of the present invention in which a user selects two or more modelling types when implementing a hybrid modelling strategy. In FIG. 9 the anechoic signal 901 is input directly into these models. Each model is used to determine a response of the environment to the anechoic signal and the response from each model is combined to provide an output response 904. It will be appreciated that such a simulating scheme provides an alternative scheme for providing accurate results but requires a drastically increased run time or hardware which is more expensive.

FIG. 10 illustrates a computer system that can be used to operate the present invention as a software computer program or hardware component. FIG. 11 shows functional elements of the computer system of FIG. 10 as a block diagram.

It is possible to run the present invention using a computer system or laptop computer. When the present invention is embodied as a computer program, the program can be stored within a memory device of the computer 1001. A user can activate and control the program using a user interface such as the computer's keyboard 1002 and mouse 1003 or any other computer user interface. The program can be viewed using a visual display unit (VDU) such as a monitor 1004. The central processing unit (CPU) 1101 of the computer will control and perform the processing required by the program as well as commands and control signals input by the user through user interfaces of the computer.

The user can define an environment to be simulated by controlling a graphical user interface (GUI) of the program using a computer user interface; the GUI can be viewed on a monitor 1004. The CPU 1101 will process the input commands of the user and store data relating to the defined space within a memory of the computer such as the internal memory 1102.

An input sound source can be input into the computer through the computer's audio input 1103. The input sound can then be stored within a memory device such as the internal memory 1102 of the computer. When the user selects for a simulation of the environment to be performed, the CPU 1101 will perform the simulation using the parameters of the defined environment stored in memory as well as the input sound. The final audio output can then be stored into internal memory 1102 or stored on a peripheral memory device 1104 such as a CD-ROM. The sound before and after processing can be listened to using a sound reproduction system such as speakers 1105 or headphones. As an alternative it is possible for pre-recorded/pre-generated sounds to be stored, for example on a hard disk of a computer or a CD-ROM. As a still further alternative the input sounds may be generated by the computer in real time using a sound synthesis algorithm.

Results of a series of tests will now be described identifying advantageous features of embodiments of the present invention.

The main objective of these tests has been to firstly demonstrate how embodiments of the present invention can be used to successfully synthesize a virtual environment such that the RIRs produced are appropriate for auralization purposes. A further objective is to evaluate the computational savings offered and what affect they may have on the resultant RIRs compared with a full 3-D render. These tests are based on a model of an actual room and data will be compared with RIR measurements obtained from within this space and with a purely geometric acoustic simulation produced using a leading commercial room acoustics software package.

The room 1200 that has been selected for measurement and modelling is a rehearsal room in the Music Department at the University of York in the UK. The room is illustrated in FIG. 12. It is relatively small, with a volume of approximately 27 m³, implying that a high sample rate 3-D DWM model can be computed reasonably. It has no soft furnishings, and all items of furniture have been removed for the purposes of this experiment. The main surfaces in the room consist of painted plasterboard, cork floor tiles, standard ceiling tiles and glass windows. Hence despite being small, the room is quite bright sounding and the lack of absorbing materials, together with parallel walls, indicate a highly modal response. A plan view of the room with the single source S and receiver positions R1-R4 marked as shown in FIG. 12. Both source and receivers are set at a height of 1.5 m with the floor to ceiling height of the room being 2.49 m.

RIR measurements for this test room are obtained for five different cases as follows:

### Case 1. Actual Test Space.

Case 1 is achieved by using a 4-channel Soundfield SPS422B B-Format microphone in each of the four receiver positions, R1-R4, to capture the response of the space to a 15 s 22 Hz-22 kHz logarithmic sine-sweep excitation, with the loudspeaker positioned at S. Deconvolution of these responses with the inverse of the sine-sweep signal yields the actual RIR. For the purposes of these experiments only the first-order W-channel B-Format omnidirectional pressure based RIR is used.

### Case 2. Geometric Acoustic Model

Based on physical measurements of the test space. Ideal impulse is applied at the input and outputs are based on a first-order W-channel omnidirectional RIR for each receiver position R1-R4. 20,000 rays were used for the simulation.

### Case 3. 3-D DWM Simulation

Based on physical measurements of the test space. Input function applied for a 3-D rectilinear mesh and the outputs at each receiver point are taken from a single air-node, equivalent to a W-channel RIR. Mesh sample rate selected such that the final bandwidth is valid to 10 kHz.

### Case 4. 2-D DWM Simulation

Based on physical measurements of the test space. Input function applied for a 2-D triangular mesh and the outputs at each receiver point are taken from a single air-node as before. Mesh sample rate selected such that the final bandwidth is valid to 22050 kHz.

### Case 5. 3-D12-D/R-T DWM Hybrid Simulation

Based on physical measurements of the test space. Input functions applied as appropriate and the outputs at each receiver point are taken from a single air-node as before. The early part is a 3-D simulation valid to 10 kHz and is truncated at 38 ms. A ray-trace model is then used for the 10-18 kHz region for the same duration. 40,000 rays are used. The reverberant tail is based on a 2-D DWM model valid to 18 kHz. Post processing is applied to obtain the final RIR wave file. Case 5 thus illustrates a a-part simulation in accordance with an embodiment of the present invention.

For both the DWM and the geometric acoustic models building materials were initially identified as closely as possible and appropriate absorption/reflection coefficients applied. Unfortunately the results were very non-ideal and resulted in predictions for the amount of time, in seconds, for reverb to decay 60 dB below the initial value (RT₆₀) that were significantly shorter than the actual measurements. Given that the space has little absorption and demonstrates strong modal effects this is not surprising. Hence a different approach was adopted and instead DWM absorption/reflection coefficients were optimised according to octave band RT₆₀ values for the actual test room and then applied to all surfaces. The values applied are shown in Table 1. Note that when the values were applied directly in the geometric acoustics package, reverberation times of 3-4 s were observed and hence values were also optimised in a similar manner. Note also that for this ‘optimised’ and hence highly reflective room, even small changes in the reflection factor values will have a potentially large influence in the final reverberation time values. In all cases, no diffusion modelling has been applied as all surfaces in the real space are hard, flat and smooth, and applied diffusion can also act to reduce RT60 values further.

TABLE 1
Octave band reflection coefficients as applied in DWM
models and in the geometric acoustics/ray-tracing cases.

| | | Geometric |
|---|---|---|
| Octave | Input | Acoustic |
| Frequency | Reflection | Reflection |
| Band (Hz) | Coefficients | Coefficients |
| 62 | 0.99 | 0.95 |
| 125 | 0.97 | 0.945 |
| 250 | 0.97 | 0.900 |
| 500 | 0.97 | 0.900 |
| 1 k | 0.96 | 0.900 |
| 2 k | 0.94 | 0.900 |
| 4 k | 0.89 | 0.900 |
| 8 k | 0.85 | 0.900 |

### Results

RT₆₀ values for each RIR are calculated in octave bands from the quantity T30 according to ISO3382 using the Aurora plug-in suite for Adobe Audition. Once generated these values are averaged across the four receiver positions to arrive at a final value to indicate the overall behaviour of the space. The results for each case are summarised in Table 2. Note first of all that there is a missing result for the 16 k octave band in Case 3 as the 3-D DWM example only has a valid bandwidth up to 10 kHz. This also affects the value in the 8 k band as it increases slightly to 0.44 s on an otherwise downwards trend. Also despite a reasonable match to the test room, the Case 2 values should not be relied upon in the lowest octave frequency bands as geometric acoustic modelling techniques are not capable of accurately simulating the acoustics of a room in this region.

TABLE 2
Octave band ISO3382-T30 values for each test
case scenario as described in Section 6.3.

| Freq. | Case | Case | Case | Case | Case |
|---|---|---|---|---|---|
| (Hz) | 1 | 2 | 3 | 4 | 5 |
| 31 | 1.63 | 2.55 | 1.22 | 1.20 | 1.37 |
| 62 | 2.20 | 2.28 | 1.31 | 1.26 | 1.32 |
| 125 | 1.30 | 1.77 | 1.14 | 1.24 | 1.28 |
| 250 | 0.97 | 1.13 | 0.99 | 1.05 | 1.09 |
| 500 | 0.91 | 0.92 | 0.71 | 1.00 | 1.00 |
| 1 k | 0.83 | 0.81 | 0.60 | 0.91 | 0.92 |
| 2 k | 0.75 | 0.76 | 0.48 | 0.73 | 0.74 |
| 4 k | 0.68 | 0.65 | 0.40 | 0.54 | 0.53 |
| 8 k | 0.53 | 0.52 | 0.44 | 0.46 | 0.43 |
| 16 k | 0.37 | 0.49 | — | 0.47 | 0.41 |

Table 3 presents comparative performance results for each of the test cases. Clearly the hybrid solutions bring the total elapsed time required to produce a complete RIR down to reasonable levels compared with a full 3-D render, which is even in this case, only valid to 10 kHz. Note that the 2-D DWM offers a good compromise when computational resources are limited.

TABLE 3
Performance data for each of the 4 simulated cases,
showing total time elapsed to produce the complete
required RIR data and the total system memory used.

| | Case 2 | Case 3 | Case 4 | Case 5 |
|---|---|---|---|---|
| Total Time | 00:54 | 64:56 | 00:26 | 03:24 |
| (Hrs:Mins) | | | | |
| Memory | — | 645 | 8 | 653 |
| Used (Mb) | | | | |

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A method for simulating wave propagation in an environment, comprising the steps of:
via a first model of the environment generated with a first modelling method, simulating a first response of the environment in a time and/or frequency domain over a first portion of the domain; and
via a further model of the environment generated with a further modelling method, simulating a further response of the environment in the time and/or frequency domain over at least one further portion of the domain.

2. The method as claimed in claim 1, further comprising the steps of:
simulating the response of the environment over the first portion of the domain which comprises information of a first level of perceptual relevance; and
simulating the response of the environment over the further portion of the domain which comprises less perceptually relevant information than the first portion of the domain.

3. The method as claimed in claim 1, further comprising the steps of:
simulating the response of the environment over the first portion of the domain via a first model having a first level of accuracy; and
simulating the response of the environment over the further portion of the domain via a further model having a level of accuracy which is less accurate than the accuracy of the first model.

4. The method as claimed in claim 1, further comprising the steps of
simulating the response of the environment over the first portion of the domain via a first model generated by a first modelling method having a first level of computational efficiency, and
simulating the response of the environment over a further portion of the domain via a further model generated by a further modelling method having a second level of computational efficiency which is more efficient than the computational efficiency of the first modelling method.

5. The method as claimed in claim 1, further comprising the steps of:
simulating the response of the environment over the first portion of the domain via a first model comprising a digital waveguide mesh of two or more dimensions.

6. The method as claimed in claim 5, further comprising the steps of:
simulating the response of the environment over the at least one further portion of the domain via a further model comprising a second digital waveguide mesh of at least one less dimension than the first digital waveguide mesh.

7. The method as claimed in claim 5, further comprising the steps of:
simulating the response of the environment over the at least one further portion of the domain via a further model comprising a digital reverb network model.

8. The method as claimed in claim 5, further comprising the steps of:
simulating the response of the environment over the at least one further portion of the domain via a further model comprising a geometric acoustic model.

9. The method as claimed in claim 8, further comprising the steps of:
simulating the response of the environment over the at least one further portion of the domain via a geometric acoustic model comprising one or more of a beam-tracing model and/or a ray-tracing model and/or an image source model.

10. The method as claimed in claim 5, further comprising the steps of:
simulating the response of the environment over the at least one further portion of the domain via a further model comprising a decaying white or coloured noise model.

11. The method as claimed in claim 5, further comprising constructing a digital waveguide mesh by the steps of:
providing a plurality of digital waveguide elements, wherein each digital waveguide element allows for bi-directional propagation of information;
providing a plurality of scattering nodes, wherein a scattering node has a plurality of input-output ports having an associated impedance characteristic and determines the propagation of information through the input-output ports; and
connecting the scattering nodes with respective adjacent digital waveguides.

12. The method as claimed in claim 11, wherein said step of providing a plurality of scattering nodes comprises the steps of:
providing a plurality of first scattering nodes, wherein for each of the first scattering nodes an output from a port of the scattering node is determined by a combination of all inputs from each port of the scattering node combined with an input of said a port of the scattering node;
providing a plurality of second scattering nodes wherein for each of the second scattering nodes a current parameter value is determined responsive to a combination of parameter values at adjacent scattering nodes at a previous time and a parameter value at the scattering node at a further time previous to said previous time; and
providing a plurality of interfacing elements, each located between respective first and second scattering nodes.

13. The method as claimed in claim 12, wherein said first scattering nodes are connected by digital waveguide elements having an associated delay characteristic.

14. The method as claimed in claim 12 wherein said previous time is one time step prior to a time when said current parameter value is determined and said further time is two time steps prior to said a time.

15. The method as claimed in claim 1, further comprising the steps of:
said a step of generating a model comprises defining a structure of the environment by constructing a geometry file for the environment, said file indicating at least one surface of the environment.

16. The method as claimed in claim 15, further comprising the steps of:
defining at least one source location and at least one receiver location in the environment.

17. The method as claimed in claim 15, further comprising the steps of:
defining one or more objects located in the environment and for each object defining one or more associated surfaces and one or more parameters associated with each surface.

18. The method as claimed in claim 1, further comprising the steps of:
selecting a first modelling method type to generate said first model; and
selecting at least one further modelling method type to generate said further model.

19. The method as claimed in claim 15, further comprising the steps of:
when said first model and/or said further model is a digital waveguide mesh, selecting at least one source location where an input signal is to be seeded and populating the defined structure of the environment with a digital waveguide mesh.

20. The method as claimed in claim 19, further comprising the steps of:
selecting a tessellating structure of connected scattering nodes and waveguides of a digital waveguide mesh.

21. The method as claimed in claim 1, further comprising the steps of:
said step of simulating wave propagation in an environment comprises combining said first response and each further response.

22. The method as claimed in claim 1, wherein said steps of simulating a first and further response comprises the steps of:
stimulating a respective model of the environment with at least one input signal; and
determining a response of the environment to the at least one input signal at least one output location.

23. The method as claimed in claim 22, further comprising the steps of:
stimulating each model with an excitation source signal;
determining a room impulse response of the environment responsive to the at least one excitation source signal; and
combining the determined response with a further anechoic input signal; whereby
a response of the combination provides a simulation of wave propagation in the environment.

24. The method as claimed in claim 22, further comprising the steps of:
stimulating each model with an anechoic input signal; whereby
a response of the model to the input signal provides a simulation of wave propagation in the environment.

25. The method as claimed in claim 1 wherein if said at least one further portion of the domain comprises a plurality of further portions of the domain, each said further portion is modelled using a different modelling method.

26. The method as claimed in claim 1 wherein said further portion of the domain overlaps at least partially with said first portion of the domain.

27. The method as claimed in claim 1 wherein said further portion of the domain is distinct from said first portion of the domain.

28. The method as claimed in claim 1 wherein said simulation of wave propagation comprises simulating propagation of acoustic sound waves in an environment.

29. The method as claimed in claim 1 wherein said environment comprises a bounded virtual space.

30. A computer program comprising computer program code means adapted to perform all the steps of claim 1 when said program is run on a computer.

31. The computer program as claimed in claim 30 embodied on a computer readable material.

32.-33. (canceled)
